(19) United States
(12) Patent Application Publication
(10) Pub. No.: US 2020/0348455 A1
(43) Pub. Date: Nov. 5, 2020

(54) IMAGING SYSTEMS WITH IMPROVED MICROLENSES

(71) Applicant: SEMICONDUCTOR COMPONENTS INDUSTRIES, LLC, Phoenix, AZ (US)

(72) Inventors: Joseph R. SUMMA, Hilton, NY (US); Christopher PARKS, Pittsford, NY (US); Scott VanALLEN, Ontario, NY (US)

(73) Assignee: SEMICONDUCTOR COMPONENTS INDUSTRIES, LLC, Phoenix, AZ (US)

(21) Appl. No.: 16/601,879

(22) Filed: Oct. 15, 2019

Related U.S. Application Data
(60) Provisional application No. 62/842,744, filed on May 3, 2019.

(51) Int. Cl. G02B 3/00

(52) U.S. Cl. CPC G02B 3/0012; G02B 3/04; G02B 3/0087

(57) ABSTRACT

An imaging device may include one or more photosensitive regions in a pixel formed as part of an image pixel array. Microlenses and color filter structures may be formed over the pixel. Each microlens may be formed from a microlens seed and one or more deposition microlens layers formed over the microlens seed. The deposition microlens layer(s) as deposited may already define the curvature of the microlens. As such, no further etching or smoothing process is need for the microlens layer(s) formed over the microlens seed. If desired, the microlens seed may have a planar top surface and planar sides, a planar top surface and slanted planar sides, or a nonplanar top surface and planar sides. The microlens seed may define microlens characteristics of the microlens such as the radius of curvature, the height, and/or the number and type of microlens lobes.

This application claims the benefit of and claims priority to provisional application No. 62/842,744, filed May 3, 2019, which is hereby incorporated by reference herein in its entirety.

### BACKGROUND

This relates generally to imaging systems and, more particularly, to imaging systems having microlens structures.

Modern electronic devices such as cellular telephones, cameras, and computers often use image sensors. Image sensors (sometimes referred to as imagers) may be formed from a two-dimensional array of image sensing pixels. Each pixel typically includes a photosensitive element such as a photodiode that receives incident photons and converts the photons into electrical signals. Each pixel may also include a microlens that overlaps and focuses light onto the photosensitive element.

Image sensors typically use organic microlenses to optimize for quantum efficiency across the visible spectrum. Although effective for visible light, these organic materials forming the microlenses exhibit low transmission characteristics for light of shorter wavelengths (e.g., wavelengths lower than wavelengths in the visible spectrum). Although inorganic materials can be used in microlenses, significant challenges exist for effectively fabricating microlens structures using inorganic materials.

It would therefore be desirable to provide improved microlenses in imaging systems.

### BRIEF DESCRIPTION OF THE DRAWINGS

FIG. 1 is a diagram showing an illustrative imaging system in accordance with some embodiments.

FIG. 2 is a cross-sectional view of a portion of an illustrative image sensor in accordance with some embodiments.

FIG. 3 is a cross-sectional view of illustrative microlens structures having a seed layer and microlens layers over the seed layer in accordance with some embodiments.

FIG. 4 is a cross-sectional view of illustrative microlens structures having a pyramidal or trapezoidal seed layer in accordance with some embodiments.

FIG. 5 is a cross-sectional view of illustrative microlens structures having a microlens seed with a nonplanar top in accordance with some embodiments.

FIGS. 6A and 6B are perspective views of illustrative top surface topologies of microlens structures formed from a microlens seed with a nonplanar top in accordance with some embodiments.

FIG. 7 is a flowchart of illustrative steps for forming microlens structures in accordance with some embodiments.

### DETAILED DESCRIPTION

Embodiments of the present invention relate to imaging systems having microlens structures with improved transmission characteristics and improved processing characteristics.

Electronic devices such as digital cameras, computers, cellular telephones, and other electronic devices include image sensors that gather incoming light to capture an image. The image sensors may include arrays of image pixels. The image pixels in the image sensors may include photosensitive elements such as photodiodes that convert the incoming light into electric charge. The electric charges may be stored and converted into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the imaging pixels and readout circuitry for reading out image signals corresponding to the electric charge generated by the photosensitive elements.

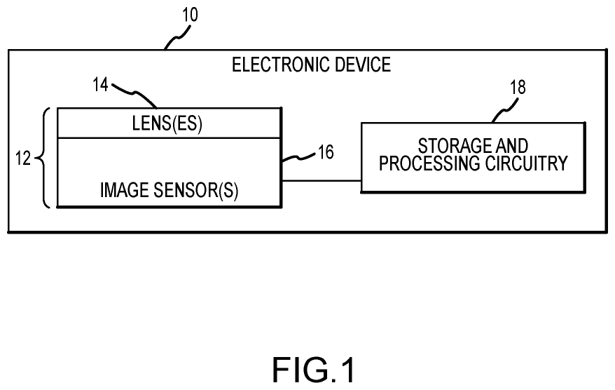

FIG. 1 is a diagram of an illustrative electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. During image capture operations, light from a scene may be focused onto image sensor 16 by lens 14. Image sensor 16 provides corresponding digital image data to processing circuitry 18. Image sensor 16 may be a front side illuminated image sensor or may, if desired, be a backside illumination image sensor. If desired, camera module 12 may be provided with an array of lenses 14 and an array of corresponding image sensors 16.

Control circuitry such as storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18. Processed image data may, if desired, be provided to external equipment (e.g., a computer or other device) using wired and/or wireless communications paths coupled to processing circuitry 18. Processing circuitry 18 may be used in controlling the operation of image sensors 16.

Image sensors 16 may include one or more arrays of image pixels. The image pixels may be formed in a semiconductor substrate using complementary metal-oxide-semiconductor (CMOS) technology, charge-coupled device (CCD) technology, or any other suitable technology. Arrangements in which the image pixels are front side illumination image pixels are sometimes described herein as an example. This is, however, merely illustrative. If desired, the image pixels may be backside illumination image pixels. The image sensor pixels may be configured to support rolling or global shutter operations. As an example, the image pixels may each include a photodiode, floating diffusion region, a local storage region, transfer transistors, or any other suitable components.

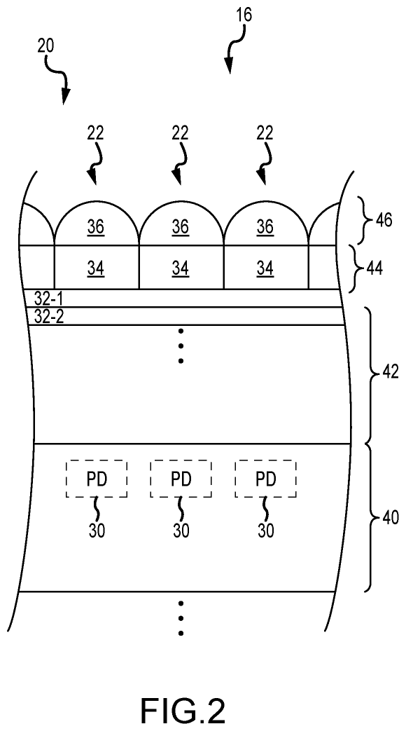

To further focus light onto the image pixels, microlenses may be formed over the image pixels. The microlenses may form an array of microlenses that overlap an array of light filter elements and the array of image sensor pixels. Each microlens may focus light from an imaging system lens onto a corresponding image pixel 22 (in FIG. 2), or multiple image pixels 22, if desired.

FIG. 2 is a cross-sectional side view of a portion of an illustrative image sensor having an array of image pixels 22. As shown in FIG. 2, each pixel 22 may include a photosensitive element such as photodiode 30. Photodiodes 30 may be formed in semiconductor substrate 40 (e.g., a p-type silicon substrate). Storage diode regions and other pixel structures (e.g., floating diffusion regions, transistors, etc.) may also be formed in substrate 40 in regions between adjacent or neighboring photodiodes 30.

An interconnect stack such as interconnect stack 42 may be formed on the surface of substrate 40. Interconnect stack 42 may include dielectric layers formed from dielectric materials such as silicon oxide (SiO₂). Interconnect layers (sometimes referred to as interconnect routing structures) may be formed in interconnect stack 42 to contact the various pixel structures and terminals and may be separated by the dielectric layers. Interconnect layers may include conductive structures such as metal signal routing paths and metal vias. The dielectric layer may sometimes be referred to as an intermetal dielectric layer, an intermetal dielectric stack, an interconnect stack, or an interlayer dielectric (ILD). Layers 32-1, 32-2, etc., in FIG. 2 may refer to one or more layers of interlayer dielectric or interconnect routing structures.

A (color) filter array in (color) filter layer 44 may be formed over interconnect stack 42. Color filter layer 44 may include an array of (color) filter elements such as (color) filter elements 34. Each (color) filter element 34 may be configured to pass light in a given portion of the electromagnetic spectrum while blocking light outside of that portion of the electromagnetic spectrum. For example, each color filter element may be configured to pass one or more of: green light, red light, blue light, cyan light, magenta light, yellow light, infrared light, ultraviolet light, and/or other types of light. If desired, a passivation layer may be interposed between color filter layer 44 and interconnect stack 42.

A microlens array in microlens layer 46 (sometimes referred to as microlens structures or microlens layers 46 for the sake of clarity when describing the multiple layers associated with microlens layer 46) may be formed over color filter layer 44. Microlens layer 46 may include a plurality of microlenses 36 each formed over a respective one of color filter elements 34. Each microlens 36 may be configured to focus light towards an associated one of photodiodes 30. If desired, each microlens 36 may be formed over multiple color filter elements 34 or share a single color filter element with another microlens 36. If desired, each microlens 36 may be configured to focus light towards multiple photodiodes 30.

In some applications, it may be desirable for an image sensor to obtain data for light of shorter wavelengths than wavelengths of visible light (e.g., ultraviolet light, deep ultraviolet light, etc.). However, if care is not taken, light of these shorter wavelengths may be significantly attenuated when passing through microlens structures. As an example, organic materials may exhibit lower transmission characteristics below 300 nanometer (nm). Hence, microlens structures formed from these organic materials may undesirably attenuate light at wavelengths of interest less than 300 nm. While other materials such as inorganic material can be used to form microlens structures, difficulties may arise when effectively fabricating microlens structures using inorganic materials. The embodiments described herein mitigate these issues while forming microlens structures with improved processing and performance.

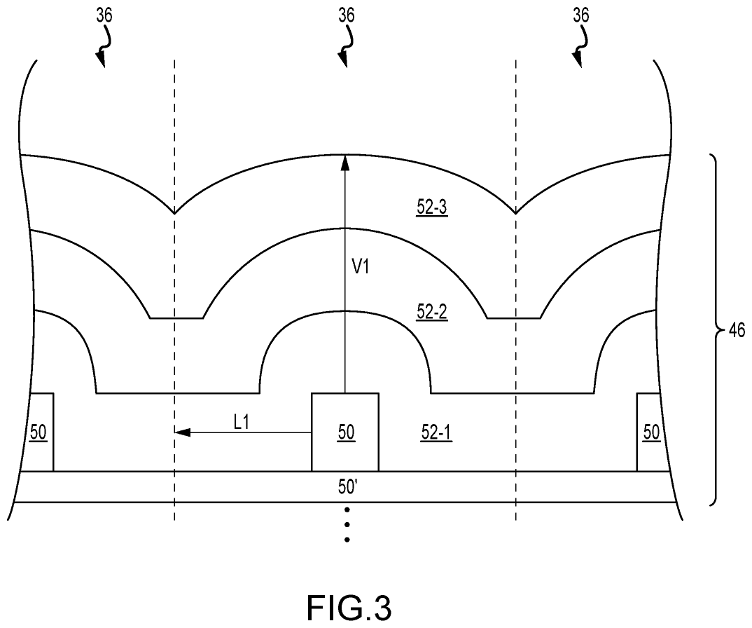

FIG. 3 is a cross-sectional view of illustrative microlens structures having a seed layer and microlens layers over the seed layer. As shown in FIG. 3, microlens 36 may be formed from seed layer 50 (sometimes referred to herein as a seed lens, a seed pillar, a microlens seed, a seed structure, a microlens seed structure, a precursor structure) and microlens layers 52-1, 52-2, and 52-3 (sometimes referred to herein as deposition layers or deposition microlens layers) formed over seed layer 50. Microlens layers 52-1, 52-2, and 52-3 and seed layer 50 may be formed from an oxide material (e.g., metal oxide material, semiconducting oxide material, any suitable type of oxide material) or any suitable type of inorganic material such as nitrides (silicon nitride), oxynitrides (silicon oxynitrides), etc. However, this is merely illustrative. If desired, one or more of layers 52-1, 52-2, 52-3 and 50 may be formed from organic materials, inorganic materials, and/or any combination of organic and inorganic materials.

While FIG. 3 shows three microlens layers (e.g., layers 52-1, 52-2, and 52-3) over seed layer 50, this is merely illustrative. If desired, a single microlens layer or more than one microlens layers may be formed over seed layer 50. While three deposition layers are sometimes described herein, the principles may similarly be applied to microlens formed from less than three deposition layers or greater than three deposition layers. If desired, layer 50′ may be formed in an integral manner with seed layer 50 (e.g., a seed layer may include a planar portion 50′ and a seed protrusion portion 50). The seed protrusion portion may be referred to as the seed lens, the seed pillar, or the microlens seed. Alternatively, layers 50 and 50′ may be formed separately using separate processes.

Seed pillar 50 may be formed as a nonspherical structure and have straight (uncurved) edges (e.g., having a noncircular side profile, having a rectangular side profile as shown in FIG. 3, having straight peripheral or lateral sides or peripheral edges, having a straight top edge) that is not the same as the final shape of microlens 36 (e.g., the top surface and side surface topology of seed pillar 50 is not an exact copy of the top surface and side surface topology of microlens 36). The shape of seed pillar 50 (e.g., the top and side surfaces of seed pillar 50) may still influence the final shape of microlens 36 (e.g., the topology of microlens 36). In other words, microlens layers 52-1, 52-2, and 52-3 may have surface profiles (sides) that are different than that of seed pillar 50 to form microlens 36. In forming microlens 36, the topmost layer (i.e., layer 52-3) may define a (spherical) shape of microlens 36 (e.g., define a top surface topology of microlens 36). The height of microlens 36 may be defined by the thickness of each of layers 50, 52-1, 52-2, and 52-3. The shape and height of microlens 36 may be tuned based the lateral and vertical deposition rates for layers 52-1, 52-2, and 52-3.

As an example, for a given microlens, layers 52-1, 52-2, and 52-3 may have vertical dimension V1 (e.g., a combined thickness V1) and may have lateral dimension L1 (e.g., a radius of the microlens L1). By adjusting the ratio of lateral and vertical deposition rates, the ratio of thickness L1 to radius V1 may be adjusted. The curvature (e.g., radius of curvature) for microlens 36 may consequently be tuned based on the ratio. In particular, it may be desirable to deposit one or more of layers 52-1, 52-2, and 52-3 (or a single integral deposition layer) where the lateral deposition rate differs substantially from (e.g., has difference of greater than 10%, of greater than 25%, of greater than 50%, of greater than 75%, etc. from) the vertical deposition rate. By adjusting the lateral deposition rate and the time for deposition, the height of microlens 36 may be tuned.

By first forming seed layer 50 and subsequently forming microlens layers 52-1, 52-2, and 52-3 using tuned (lateral and vertical) deposition rates and times, microlens 36 may be formed without etching (e.g., smoothing or polishing) layers 52-1, 52-2, and 52-3. In other words, after forming seed pillar 50, etch smoothing steps for deposition microlens (oxide) layers may be omitted. The microlens layers may themselves fully fill all of the space between adjacent seed pillars 50 to form microlens 36 in the desired manner. If desired, seed pillar 50 may be formed using an etch step. However, the final shape, curvature, or (top surface) topology of microlens 36 may be defined without an etch smoothing step (e.g., topmost layer 52-3 is not etched (i.e., unetched) to form a desirable curvature and/or height of microlens 36).

If desired, microlens layers 52-1, 52-2, and 52-3 may be formed using different materials. As an example, layers 52-1, 52-2, and 52-3 may be configured to reduce or minimize reflective loss. In particular, layers 52-1, 52-2, and 52-3 may be formed a gradient of layers having decreasing indices of refraction (i.e., refractive indices). In other words, the bottommost layer (e.g., layer 52-1) may be formed from material having the highest index of refraction (e.g., silicon nitride), the topmost layer (e.g., layer 52-3) may be formed from material having the lowest index of refraction (e.g., silicon oxide), and the middle layer (e.g., layer 52-2) may be formed from material having an intermediate index of refraction between the highest and lower indices of refraction (e.g., silicon oxynitride). If desired, a layer formed from a gradient-index material having a continuous refractive index gradient may be formed over seed layer 50 instead of or in addition to layers 52-1, 52-2, and 52-3.

If desired, one or more of microlens layers 52-1, 52-2, and 52-3 may be formed from passivation material (e.g., silicon oxynitride). The silicon oxynitride layer may serve as a passivation layer to protect the imaging device (e.g., one or more layers and/or a substrate over which the passivation layer is formed). If desired, the passivation layer may protect the imaging device from moisture. Incorporating passivation layers into the microlens layers may help reduce overall stack height of the imaging device. If desired, a topmost layer (or any suitable layer) for microlens 36 may be an anti-reflective coating layer. If desired, an anti-reflective coating layer may be formed over the topmost layer forming microlens 36.

While seed pillar 50 is shown to have a rectangular shape in FIG. 3, this is merely illustrative. If desired seed pillar 50 may have any suitable shape. In particular, the topology of seed layer 50 may adversely impact the overlap shape of microlens 36. As such, to reduce the impact of the seed layer topology, seed layer 50 may be formed using a pyramidal, pointed, conical, or trapezoidal shape.

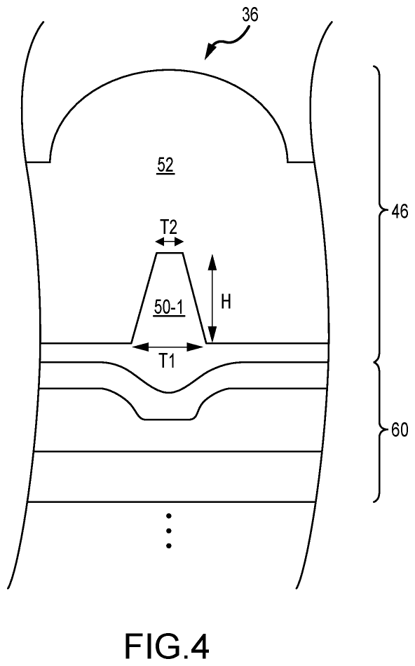

FIG. 4 is a cross-sectional view of illustrative microlens structures having a pyramidal or trapezoidal seed layer. FIG. 4 shows seed layer 50-1 having a base width (e.g., width/diameter T1, a bottom lateral dimension) and a top width (e.g., width/diameter T2, a top lateral dimension parallel to the bottom lateral dimension) at the protruding portion of seed layer 50-1. Base width T1 may be greater than (e.g., may be around 50% greater than, may be around 40% greater than, may be around 60% greater than, may be any suitable amount greater than) top width T2 to provide a desirable shape for microlens 36 and to reduce the effects of seed layer topology on final microlens shape. Seed layer 50-1 may also have a height (e.g., height H, a vertical dimension H). If desired, height H 50-1 may be adjusted to tune the characteristics of microlens 36 (e.g., the thickness or height of microlens 36). If desired, height H may be adjusted to selected a suitable top width T2. As an example, with a pyramidal or trapezoidal seed structure (e.g., a pyramidal or trapezoidal precursor), microlens 36 may be formed without any undesirable dents or lobes in the final profile.

The seed pillar in seed layer 50-1 may be at least used to tune the shape of microlens 36 (in combination with microlens layer 52). In other words, the seed pillar of seed layer 50-1 may have a planar top surface (or a sharp top point) and slanted sides, thereby having a profile that correlates better (than a seed pillar having a rectangular profile) to a curvature of a final microlens shape. In this manner, fewer deposition microlens layers and/or a thinner microlens layer 52 may be formed. This may desirably reduce the thickness of the microlens.

Furthermore, FIG. 4 shows how microlens structures 46 may be formed on other device layers 60. This may be similarly the case in the configuration of FIG. 3 (e.g., under layer 50′). Layers 60 may include any combination of the device layers described in connection with FIG. 2 (e.g., layers 44, 32-1, 32-2, substrate 40, etc.). If desired, layers 60 may include any additional layers not shown in FIG. 2 such as oxynitride layers, transistor gate layers, lights shield layers, etc. If desired, the topmost layer in layers 60 may be a nonplanar layer (having recessed regions and protruding regions) or may be a planar layer. In particular, when forming seed layer 50-1, seed layer 50-1 may be formed over the topmost device layer in layers 60. Microlens layer 52 (e.g., a combination of layers 52-1, 52-2, and 52-3 formed from the same material, a single microlens layer, a combination of multiple different microlens layers formed using different materials, etc.) may be formed over seed layer 50-1.

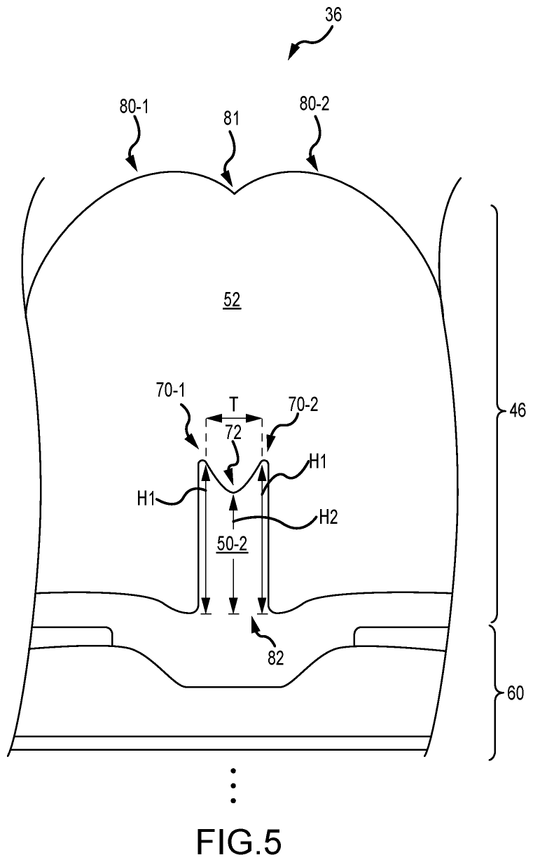

In some embodiments, a microlens seed (pillar) may be formed from irregular shapes. FIG. 5 is a cross-sectional view of illustrative microlens structures having a microlens seed with a nonplanar top. In the example of FIG. 5, microlens seed 50-2 that has an irregular top surface (e.g., a non-planar top surface, a curved top surface, a concave top surface). In particular, microlens seed 50-2 may have rising edges or points, or protruding portions 70-1 and 70-2 (having a height of H1 from base 82 of microlens seed 50-2) and depression or recession 72 in the center (having a height of H2 from base 82). Protruding portions 70-1 and 70-2 may be separated by a lateral distance T.

Formed in this manner, the two rising edges 70-1 and 70-2 may produce a microlens with multiple (e.g., two) focal points after microlens layer 52 is deposited. As an example, one or more oxide, oxynitride, and nitride materials may be deposited as microlens layer 52. In other words, the non-planar shape of the top surface of microlens seed 50-2 may transfer to the overall (final) shape of microlens 36 having multiple lobes to exhibit multiple focal points. In the example of FIG. 5, rising edge 70-1 may translate (e.g., be used to at least partially define) to lobe 80-1 and rising edge 70-2 may translate (e.g., be used to at least partially define) to lobe 80-2. Depression 72 in microlens seed 50-2 may translate (e.g., be used to at least partially define) to depression 81 in microlens 36. Distance T between protruding portions 70-1 and 70-2 may be adjusted to adjust a separation of lobes 80-1 and 80-2 from each other (e.g., may adjust the separation between respective peak points in lobes 80-1 and 80-2). The shape and curvature of each lobe may be tuned using the shape and curvature of microlens seed 50-2, separation between protruding portions of microlens seed 50-2, and/or deposition rates of microlens layers.

The example of microlens 36 in FIG. 5 is merely illustrative. If desired, the underlying seed topology may be raised at more than two points to form more than two lobes or may be raised at one point. If desired, points 70-1 and 70-2 may be at different heights and may be separated by distance T. If desired, microlens seed 50-2 may have any suitable nonplanar top surface topology defined by a suitable number of points at any set of differing heights.

As an example, a microlens with multiple focal points may be placed over phase detection autofocus pixels (PDAF pixels). If desired, the microlens with multiple focal points may be used with any pixels to perform phase detection and/or auto focusing operations. If desired, the microlens with multiple lobes exhibiting multiple focal points may be used for any suitable operations.

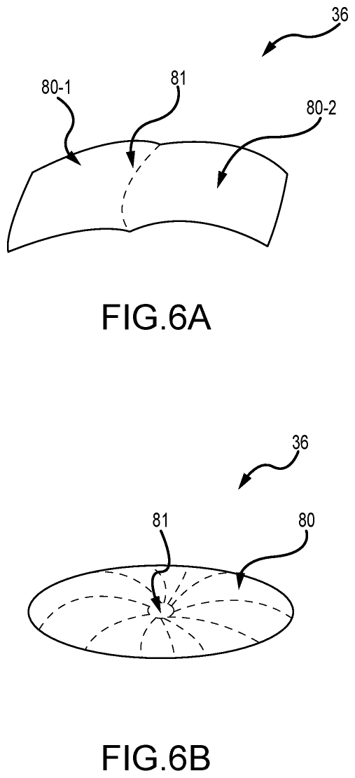

FIG. 6A is a perspective view of a microlens top surface topology for microlens 36 having two lobes that may be formed from the microlens seed 50-2 in FIG. 5. In the example of FIG. 6A, microlens 36 may have bilateral or planar symmetry across a vertical plane through recessed region 81. In other words, lobe 80-1 may be formed as a mirrored version of lobe 80-2 (and vice versa) across the vertical plane. Recess region 81 may separate lobe 80-1 from lobe 80-2. In this example of FIG. 6A, microlens seed 50-2 (in FIG. 5) may similarly have bilateral or planar symmetry across a vertical plane through recessed region 72 (e.g., a vertical plane through both recessed region 72 and recessed region 81). In other words, protruding portion 70-1 may be formed as a mirrored version of protruding portion 70-2 (and vice versa) across the vertical plane.

If desired, microlens 36 in FIG. 6A may be formed over a (PDAF) pixel. Lobe 80-1 may overlap (e.g., be formed over) a first photosensitive region in the pixel, and lobe 80-2 may overlap (e.g., be formed over) a second photosensitive region in the pixel.

FIG. 6B is a perspective view of a microlens top surface topology for microlens 36 having a continuous lobe that may be formed from the microlens 50-2 in FIG. 5. In the example of FIG. 6B, microlens 36 may have radial symmetry about an axis through the central recessed portion 81. Recessed portion 81 may have a circular or any suitable curved shape, or may be a point. Lobe 80 may have a continuous surface that has a convex shape extending from the peripheral outer edges of microlens 36 to the inner recessed portion 81. In this example of FIG. 6B, microlens seed 50-2 may similarly have radial symmetry about a central axis through the central recessed portion 72 (e.g., a central axis through both recessed region 72 and recessed region 81). In other portions, protruding portions 70-1 and 70-2 may be connected to each other (and have a circular shape) and may laterally surround recessed portion 72 (e.g., may have radial symmetry about the central axis).

If desired, microlens 36 in FIG. 6B may be formed over a (donut) pixel (e.g., a pixel having a first inner photosensitive region and a second outer photosensitive region that surrounds the first inner photosensitive region). Central recess portion 72 may overlap (e.g., may be formed over) at least the first (inner) photosensitive region, and lobe 80 may overlap (e.g., may be formed over) at least the second (outer) photosensitive region.

The microlens topology and microlens seed topology described in connection with FIGS. 5, 6A, and 6B are merely illustrative. If desired, the topology of the microlens seed may be tuned in any suitable manner to arrive a suitable topology of microlens 36. While not explicitly shown in FIGS. 6A and 6B, deposition microlens layer 52 may be interposed between recessed portion 81 of microlens 36 in FIGS. 6A and 6B and recessed portion 72 of microlens seed 50-2 in FIG. 5.

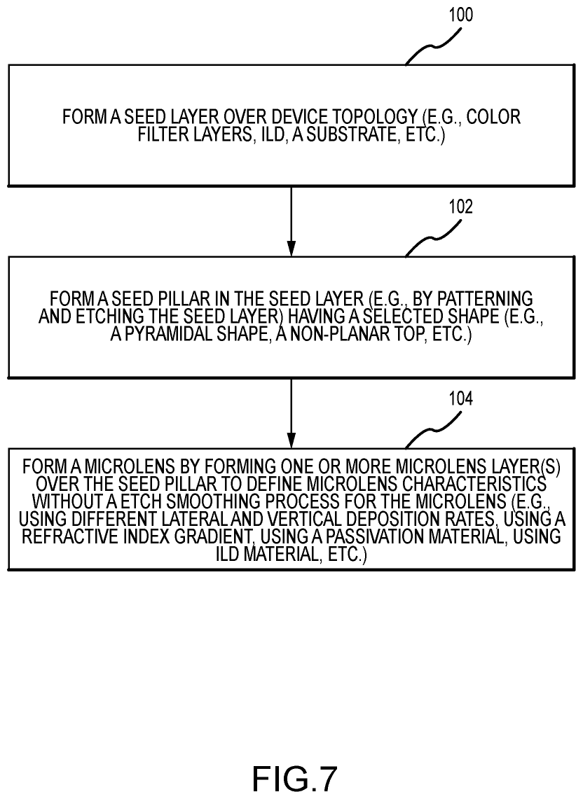

FIG. 7 shows illustrative steps for forming microlenses of the types shown in FIGS. 2-6. In particular, at step 100, a seed layer may be formed over the existing device topology (e.g., over previously formed color filter layers, interlayer dielectric, a semiconductor substrate, etc.). As an example, a seed layer may first be deposited over the existing device topology using any suitable deposition process (e.g., a deposition process for inorganic materials).

At step 102, a microlens seed or seed pillar may be formed in the seed layer (e.g., by patterning and etching the seed layer). The seed pillar may be formed to have a desired shape (e.g., a pyramidal shape described in FIG. 4, a shape having a non-planar top described in FIG. 5, a rectangular shape described in FIG. 3, or any other suitable shape or topology). As an example, the seed layer may be selectively etched (e.g., using a masking layer) to form the seed pillar having the desired shape having the desired (peripheral and top) side characteristics (e.g., curved sides, recessed portions, slanted sides, etc.). If desired, the seed layer may be patterned and etched using more than one masking layer and/or more than one etch step.

At step 104, one or more microlens layers may be formed over the seed pillar to define microlens characteristics (e.g., a final microlens shape, a final microlens height, a radius of curvature of a microlens, a radius of a microlens, a number of lobes of a microlens, reflectivity of a microlens etc.). As an example, the one or more micros lens layers may be deposited using any suitable deposition process (e.g., a deposition process for inorganic materials). The microlens characteristics may be defined without an etch smoothing process (e.g., without etching the one or more microlens layers). The microlens characteristics may be formed by forming the one or more microlens layers based on different lateral and vertical deposition rates, using a refractive index gradient, using a passivation material, using interlayer dielectric material, etc.

In some configurations, a method of forming a microlens in an imaging system includes forming a microlens seed structure, depositing a first microlens layer over the microlens seed structure, depositing a second microlens layer over the first microlens layer and over the microlens seed structure, and depositing a third microlens layer interposed between the first microlens layer and the second microlens layer. Depositing the first, second, and third microlens layers may include depositing one or more inorganic materials using a lateral deposition rate that is substantially different than a vertical deposition rate. The deposited second microlens layer may define a top surface topology of the microlens (e.g., the deposited second microlens layer may have a top surface that is the same as a top surface of the microlens). The top surface topology may have a first curvature that is different than a second curvature of a top surface of the microlens seed structure.

As a first example, forming the microlens seed structure may include forming the top surface of the microlens seed structure as a planar surface, and forming a peripheral side of the microlens seed structure as a slanted surface. As a second example, forming the microlens seed structure may include forming the top surface of the microlens seed structure with a recessed portion having a first height from a base of the microlens seed structure and a protruding portion having a second height from the base of the microlens seed structure that is greater than the first height, and forming the top surface of the microlens seed structure with an additional protruding portion having the second height from the base of the microlens seed structure, the recessed portion being interposed between the protruding portion and the additional protruding portion. The top surface topology of the microlens may have first and second lobes, the first lobe being at least partly defined by the protruding portion, and the second lobe being at least partly defined by the additional protruding portion.

In some configurations, an image sensor may include an image sensor pixel array and a microlens that overlaps a portion of the image sensor pixel array. The microlens may include a microlens precursor structure having a top surface and a base that opposes the top surface, the microlens precursor structure having a protruding portion at the top surface that surrounds a recessed portion at the top surface, and a deposition microlens layer formed over the top surface of the microlens precursor structure, the deposition microlens layer defining a top surface of the microlens.

As a first example, the protruding portion may include first and second protruding structures having planar symmetry across a plane through the recessed portion, the first protruding structure at least partly defining a first lobe of the microlens and the second protruding structure at least partly defining a second lobe of the microlens. The first lobe of the microlens may be configured to focus light onto a first photosensitive region in the image sensor pixel array and the second lobe of the microlens may be configured to focus light onto a second photosensitive region in the image sensor pixel array. As a second example, the protruding portion may have radial symmetry around an axis through the recessed portion. The deposition microlens layer may have a depressed portion, and the axis may extend through the depressed portion. The protruding portion may have a first height from the base that is greater than a second height of the recessed portion from the base.

In some configurations, a microlens may include a microlens seed pillar having a top lateral width at a top surface, a bottom lateral width at a base that is greater than the top lateral width, and a slanted planar side surface that connect top surface to the base, and may include a plurality of microlens layers formed over the microlens seed pillar, a topmost layer in the plurality of microlens layers defining a top surface topology of the microlens. The topmost layer may be unetched. The plurality of microlens layers is formed from at least one material of oxide materials, nitride materials, and oxynitride materials.

The foregoing is merely illustrative of the principles of this invention and various modifications can be made by those skilled in the art. The foregoing embodiments may be implemented individually or in any combination.

What is claims is:

1. A method of forming a microlens in an imaging system, the method comprising:
forming a microlens seed structure; and
depositing a first microlens layer over the microlens seed structure, wherein the deposited first microlens layer defines a top surface topology of the microlens, the top surface topology having a first curvature that is different than a second curvature of a top surface of the microlens seed structure.

2. The method defined in claim 1, wherein the deposited first microlens layer has a top surface that is the same as a top surface of the microlens.

3. The method defined in claim 2, wherein depositing the first microlens layer comprise depositing an inorganic material.

4. The method defined in claim 3, wherein depositing the first microlens layer comprises depositing the inorganic material using a lateral deposition rate that is substantially different than a vertical deposition rate.

5. The method defined in claim 1, wherein the first microlens layer is formed from a gradient-index material having a refractive index gradient.

6. The method defined in claim 1, further comprising:
depositing a second microlens layer over the microlens seed structure; and
depositing a third microlens layer interposed between the first and second microlens layers, wherein the first microlens layer has a first refractive index, the second microlens layer has a second refractive index less than the first refractive index, and the third microlens layer has a third refractive index greater than the first refractive index and less than the second refractive index.

7. The method defined in claim 1, wherein forming the microlens seed structure comprises:
forming the top surface of the microlens seed structure as a planar surface; and
forming a peripheral side of the microlens seed structure as a slanted surface.

8. The method defined in claim 1, wherein forming the microlens seed structure comprises:
forming the top surface of the microlens seed structure with a recessed portion having a first height from a base of the microlens seed structure and a protruding portion having a second height from the base of the microlens seed structure that is greater than the first height.

9. The method defined in claim 8, wherein forming the microlens seed structure comprises:
forming the top surface of the microlens seed structure with an additional protruding portion having the second height from the base of the microlens seed structure, the recessed portion being interposed between the protruding portion and the additional protruding portion.

10. The method defined in claim 9, wherein the top surface topology of the microlens has first and second lobes, the first lobe being at least partly defined by the protruding portion, and the second lobe being at least partly defined by the additional protruding portion.

11. An image sensor comprising:
an image sensor pixel array; and
a microlens that overlaps a portion of the image sensor pixel array, the microlens comprising:
a microlens precursor structure having a top surface and a base that opposes the top surface, wherein the microlens precursor structure has a protruding portion at the top surface that surrounds a recessed portion at the top surface; and
a deposition microlens layer formed over the top surface of the microlens precursor structure, wherein the deposition microlens layer defines a top surface of the microlens.

12. The microlens defined in claim 11, wherein the protruding portion comprises first and second protruding structures having planar symmetry across a plane through the recessed portion.

13. The microlens defined in claim 12, wherein the first protruding structure at least partly defines a first lobe of the microlens and the second protruding structure at least partly defines a second lobe of the microlens.

14. The microlens defined in claim 13, wherein the first lobe of the microlens is configured to focus light onto a first photosensitive region in the image sensor pixel array and the second lobe of the microlens is configured to focus light onto a second photosensitive region in the image sensor pixel array.

15. The microlens defined in claim 11, wherein the protruding portion has radial symmetry around an axis through the recessed portion.

16. The microlens defined in claim 15, wherein the protruding portion has a first height from the base that is greater than a second height of the recessed portion from the base.

17. The microlens defined in claim 15, wherein the deposition microlens layer has a depressed portion and the axis extends through the depressed portion.

18. A microlens comprising:
a microlens seed pillar having a top lateral width at a top surface, a bottom lateral width at a base that is greater than the top lateral width, and a slanted planar side surface that connect top surface to the base; and
a plurality of microlens layers formed over the microlens seed pillar, a topmost layer in the plurality of microlens layers defining a top surface topology of the microlens.

19. The microlens defined in claim 18, wherein the plurality of microlens layers is formed from at least a material selected from the group consisting of oxide materials, nitride materials, and oxynitride materials.

20. The microlens defined in claim 18, wherein the topmost layer is unetched.

21. The microlens defined in claim 18, wherein at least one of the plurality of microlens layers is formed from a passivation material.
